(19) United States
(12) Patent Application Publication
(10) Pub. No.: US 2026/0066468 A1
(43) Pub. Date: Mar. 5, 2026

(54) SECONDARY BATTERY AND PREPARATION METHOD THEREOF, AND ELECTRIC DEVICE

(71) Applicant: SUNWODA MOBILITY ENERGY TECHNOLOGY CO., LTD., Guangdong (CN)

(72) Inventors: Lin ZHANG, Guangdong (CN); Zhong CHENG, Guangdong (CN)

(73) Assignee: SUNWODA MOBILITY ENERGY TECHNOLOGY CO., LTD., Guangdong (CN)

(21) Appl. No.: 19/382,286

(22) Filed: Nov. 7, 2025

Related U.S. Application Data
(63) Continuation of application No. PCT/CN2024/091584, filed on May 8, 2024.

(30) Foreign Application Priority Data
Jul. 20, 2023 (CN) 202310898227.1

(51) Int. Cl. H01M 50/46; H01M 50/403; H01M 50/411; H01M 50/443; H01M 50/449; H01M 50/491

(52) U.S. Cl. CPC H01M 50/46; H01M 50/403; H01M 50/411; H01M 50/443; H01M 50/449; H01M 50/491

(57) ABSTRACT

A secondary battery, including a positive electrode sheet, a negative electrode sheet, and a separator. The separator includes a base membrane and a coating arranged on at least one surface of the base membrane; the coating includes a composite polymer and a binder, and the composite polymer includes a first polymer for an inner core layer and a second polymer for a cladding layer arranged on the surface of the inner core layer; the peel strength between the separator and the positive electrode sheet is 1-5 N/m, and the thermal shrinkage rate of the separator in MD and TD directions is less than 5% at 130° C. for 0.5 h.

### CROSS-REFERENCE TO RELATED APPLICATION

This application is a continuation of international application of PCT application serial no. PCT/CN2024/091584, filed on May 8, 2024, which claims the priority benefit of China application no. 202310898227.1, filed on Jul. 20, 2023. The entirety of each of the above-mentioned patent applications is hereby incorporated by reference herein and made a part of this specification.

### BACKGROUND

### Technical Field

The present application belongs to the field of new energy, specifically to a secondary battery and preparation method thereof.

### Description of Related Art

In secondary batteries, to improve the heat resistance of the separator, inorganic particle coatings with high heat resistance can be applied on one or both sides of the base membrane, but their density is relatively high, which is not conducive to improving battery performance. Furthermore, the separators currently used in the market have issues such as poor adhesion to the positive and negative electrode sheets, especially for power batteries, which require high adhesion strength between the separator and the electrode sheets to ensure high battery integrity for easy assembly. However, related coating design schemes require high temperature and pressure, and the adhesion strength is difficult to meet requirements.

### SUMMARY

A first aspect of the present application provides a secondary battery, including a positive electrode sheet, a negative electrode sheet, and a separator, where the separator includes a base membrane and a coating disposed on at least one surface of the base membrane; the coating includes a composite polymer and a binder, the composite polymer including a first polymer for a core layer and a second polymer for a cladding layer disposed on the surface of the core layer; the peel strength between the separator and the positive electrode sheet is 1-5 N/m; the thermal shrinkage rate of the separator in the MD and TD directions is less than 5% at 130° C. for 0.5 h.

In some embodiments, the peel strength between the separator and the negative electrode sheet is 1-5 N/m.

In some embodiments, the first polymer includes at least one of polybenzimidazoleimide, polybenzothiazole, polybenzazole, polybenzoxazinone, polyimidazopyrrolone, polyether sulfone, polyphenylene sulfide, polyether ketone, polydiphenylether, phenyl polyphenylene, polyparaxylene, bisphenol A-type polyarylate, poly(p-hydroxybenzoate), and polyparabanic acid.

In some embodiments, the second polymer includes at least one of polyacrylics, polyacrylates, nitrile rubber, chloroprene rubber, polyvinyl alcohols, or copolymers formed from any two thereof.

In some embodiments, the particle size of the composite polymer is 0.1-10 μm.

In some embodiments, the binder includes at least one of vinylidene fluoride, carboxymethyl cellulose, and styrene-butadiene rubber.

In some embodiments, the thickness of the coating is 0.2-10 μm.

A second aspect of the present application provides a preparation method for the above-mentioned secondary battery, including adding particles of the first polymer into an emulsion of the second polymer, then mixing, stirring, heating, and drying to obtain the composite polymer;
mixing the composite polymer, the binder, and water to form a slurry, applying the slurry on at least one surface of the base membrane, curing to form the coating, and obtaining the separator.

In some embodiments, the mass ratio of the particles of the first polymer to the emulsion of the second polymer is (14-20):(1-6).

In some embodiments, the mass ratio of the composite polymer to the binder is (90-99.5):(0.5-10).

A third aspect of the present application provides an electric device including the above-mentioned secondary battery.

In the secondary battery of the present application, for the composite polymer of the coating of the separator, the core layer adopts a first polymer with a melting point of 180-400° C., and the cladding layer adopts a second polymer with a softening temperature of 40-70° C. The combination of high melting point polymer and low softening temperature polymer exhibits a synergistic effect, enabling the constructed composite polymer coating material to achieve high adhesion strength and high heat resistance of the composite separator through a single coating application.

### BRIEF DESCRIPTION OF THE DRAWINGS

The drawings forming a part of the present application are provided to further understand the present application. The illustrative embodiments and descriptions of the present application are used to explain the present application and do not constitute an improper limitation of the present application.

FIG. 1 is a schematic structural diagram of a composite separator according to an embodiment of the present application.

FIG. 2 is an electron microscope image of a composite polymer according to an embodiment of the present application.

### DESCRIPTION OF THE EMBODIMENTS

The present application discloses a secondary battery and its preparation method. Those skilled in the art can refer to the content herein and appropriately improve process parameters for implementation. It should be particularly pointed out that all similar replacements and modifications are obvious to those skilled in the art and are considered to be included in the present application. The method described in the present application has been described through preferred embodiments. It is apparent that relevant personnel can make modifications or appropriate changes and combinations to the method described herein without departing from the content, spirit, and scope of the present application to realize and apply the technology of the present application. Obviously, the described embodiments are part of the embodiments of the present application, not all of them. Based on the embodiments in the present application, all other embodiments obtained by those of skill in the art without creative work shall fall within the protection scope of the present application.

It should be noted that in this application, relation terms such as “first” and “second,” “step 1” and “step 2,” and “(1)” and “(2)” are used merely to distinguish one entity or operation from another, without necessarily requiring or implying any such actual relationship or sequence between these entities or operations. Furthermore, the term “including”, “comprising” or any other variation thereof is intended to cover a non-exclusive inclusion, such that a process, method, article, or device that includes a series of elements includes not only those elements but also other elements not explicitly listed, or elements inherent to such process, method, article, or device. Without further limitation, an element defined by the phrase “including a . . . ” does not preclude the presence of additional identical elements in the process, method, article, or device that includes said element. Furthermore, unless conflicting, the embodiments and features described herein may be combined with each other.

A first aspect of the present application provides a secondary battery, including a positive electrode sheet, a negative electrode sheet, and a separator, where the separator includes a base membrane and a coating disposed on at least one surface of the base membrane; the coating includes a composite polymer and a binder, the composite polymer including a first polymer for a core layer and a second polymer for a cladding layer disposed on the surface of the core layer; the peel strength between the separator and the positive electrode sheet is 1-5 N/m; at 130° C. for 0.5 h, the thermal shrinkage rate of the separator in the machine direction (MD) and transverse direction (TD) is less than 5%. The coating structure is provided with a core layer and a cladding layer. Since the core layer is tightly coated by the cladding layer, the risk of the polymer of the core layer falling off from the separator coating during long-term battery cycling is effectively reduced. In some embodiments, the peel strength between the separator and the positive electrode sheet can be 1 N/m, 2 N/m, 3 N/m, 4 N/m, 5 N/m, or a range formed by any two of them. In some embodiments, at 130° C. for 0.5 h, the thermal shrinkage rate of the separator in the MD and TD directions can be 0.5%, 1%, 2%, 3%, 4%, 5%, or a range formed by any two of them. The separator of the present application has high heat resistance and adhesion.

In some embodiments of the present application, the peel strength between the separator and the negative electrode sheet can be 1-5 N/m. In some embodiments, the peel strength between the separator and the negative electrode sheet can be 1 N/m, 2 N/m, 3 N/m, 4 N/m, 5 N/m, or a range formed by any two of them.

In some embodiments of the present application, the first polymer includes at least one of polybenzimidazoleimide, polybenzothiazole, polybenzazole, polybenzoxazinone, polyimidazopyrrolone, polyether sulfone, polyphenylene sulfide, polyether ketone, polydiphenylether, phenyl polyphenylene, polyparaxylene, bisphenol A-type polyarylate, poly(p-hydroxybenzoate), and polyparabanic acid. The melting point of the above polymers is 180-400° C., which can make the separator have high heat resistance.

In some embodiments of the present application, the second polymer includes at least one of polyacrylics, polyacrylates, nitrile rubber, chloroprene rubber, polyvinyl alcohols, or copolymers formed from any two thereof. The softening temperature of the above polymers is 40-70° C., which can make the separator have high adhesion strength.

In some embodiments of the present application, the polyacrylics include at least one selected from the group consisting of polyacrylic acid, polymethacrylic acid, poly(2-ethylacrylic acid), poly(2-propylacrylic acid), and polybutylacrylic acid.

In some embodiments of the present application, the polyacrylates include at least one selected from the group consisting of polymethyl methacrylate, polyethyl methacrylate, polyisobutyl methacrylate, polyhydroxypropyl acrylate, polymethyl acrylate, and polybutyl acrylate.

In some embodiments of the present application, the polyvinyl alcohols include at least one selected from the group consisting of polyvinyl alcohol and polyvinyl acetal, where the polyvinyl acetal includes at least one selected from the group consisting of polyvinyl formal, polyvinyl acetaldehyde, polyvinyl butyral, and polyvinyl furfural.

In other embodiments of the present application, the first polymer and the second polymer in the composite polymer include any one of the following combinations:
polybenzimidazoleimide and polyacrylics, polybenzazole and polyacrylates copolymer, polyether sulfone and polyacrylics copolymer, polybenzimidazoleimide and polyacrylics copolymer.

In other embodiments of the present application, the mass ratio of the first polymer to the second polymer is (14-20):(1-6), in one embodiment, the mass ratio is (15-20):(1-4), in one embodiment, the mass ratio is (16-18):(1-4). The mass ratio of the first polymer to the second polymer being within the scope of the present application is conducive to coordinating the heat resistance and adhesion of the separator.

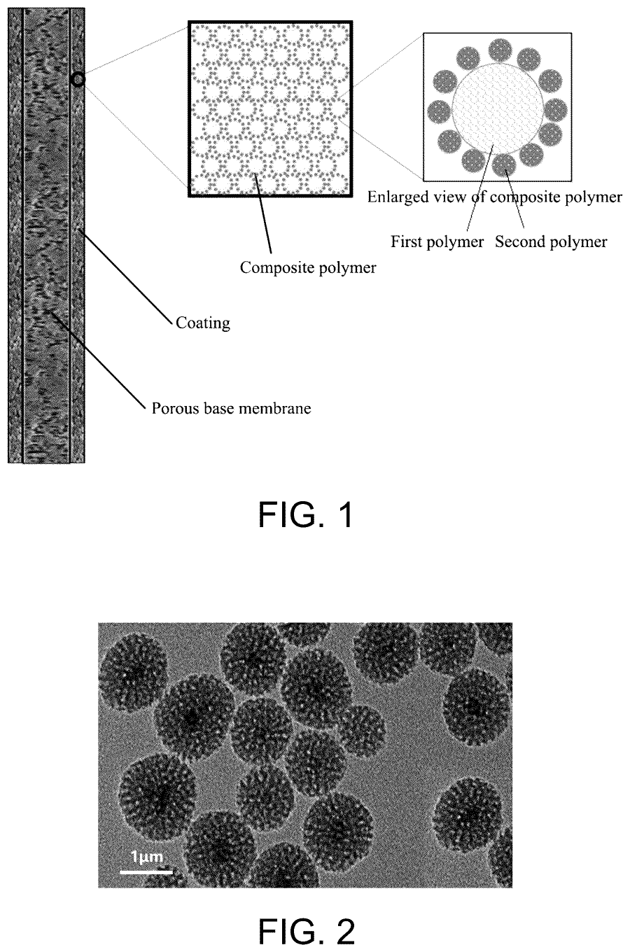

The schematic diagram of the composite polymer structure is shown in FIG. 1, and the SEM image is shown in FIG. 2. In composite polymers, the first polymer with high heat resistance serves as the core, while the second polymer with high adhesion serves as the cladding layer. The polymer with high heat resistance is tightly coated by the polymer with high adhesion, effectively reducing the risk of the polymer with high heat resistance falling off from the separator coating during long-term battery cycling. Using the polymer with high adhesion as the cladding layer can effectively bond the core polymer and make the adhesion between the coating and the separator tighter.

In some embodiments of the present application, the porosity of the base membrane is 35%-60%.

In some embodiments of the present application, the particle size of the composite polymer is 0.1-10 μm. In one embodiment, the particle size of the composite polymer is 0.1-7 μm, in one embodiment, the particle size of the composite polymer is 0.1-5 μm. The particle size of the composite polymer being within the scope of the present application is conducive to improving the air permeability of the separator.

In some embodiments of the present application, the binder includes at least one selected from the group consisting of polyvinylidene fluoride (PVDF), carboxymethyl cellulose (CMC), and styrene-butadiene rubber (SBR). The use of water-based binder in this application facilitates a tighter bonding between the composite polymer and the base membrane while also promoting the structural stability of the composite polymer.

In some embodiments of the present application, in the coating, the mass ratio of the composite polymer to the binder is (90-99.5):(0.5-10). In one embodiment, the mass ratio is (93-99):(1-7), in one embodiment, the mass ratio is (95-99):(1-5). The mass ratio of the composite polymer to the binder being within the scope of the present application is conducive to improving the comprehensive performance of the separator.

In some embodiments of the present application, the thickness of the coating is 0.2-10 μm, in one embodiment, the thickness of the coating is 0.2-7 μm, in one embodiment, the thickness of the coating is 1-5 μm. The thickness of the coating being within the scope of the present application is conducive to coordinating the relationship between high heat resistance, high adhesion, and air permeability of the separator.

In the second aspect of the present application, a preparation method for the above-mentioned secondary battery is provided, including adding particles of the first polymer into an emulsion of the second polymer, then mixing, stirring, heating, and drying to obtain the composite polymer;
mixing the composite polymer, the binder, and water to form a slurry, applying the slurry on at least one surface of the base membrane, curing to form the coating, and obtaining the separator.

In some embodiments of the present application, the particles of the first polymer can be obtained by in-situ preparation, dissolution and re-granulation of polymer resin, etc.; the second polymer is an emulsion polymer.

In some embodiments of the present application, the stirring and heating include stirring at 40-100° C. for 0.5-10 h; the heating temperature in some embodiments is 40° C., 45° C., 50° C., 55° C., 60° C., 65° C., 70° C., 75° C., 80° C., 85° C., 90° C., 95° C., 100° C., or a range formed by any two of them; the stirring time in some embodiments is 0.5 h, 1 h, 2 h, 3 h, 4 h, 5 h, 6 h, 7 h, 8 h, 9 h, 10 h, or a range formed by any two of them. The stirring and heating conditions within the scope of the application are conducive to promoting uniform mixing of the slurry without destroying the structure of the composite polymer.

In some embodiments of the present application, the drying is performed at 50-85° C.; in some embodiments, the drying is performed at 50° C., 55° C., 60° C., 65° C., 70° C., 75° C., 80° C., 85° C., or a range formed by any two of them. Under the conditions of stirring, heating, and drying within the scope of the application, it is conducive to promoting uniform mixing of the slurry without destroying the structure of the composite polymer.

In some embodiments of the present application, the mass ratio of the particles of the first polymer to the emulsion of the second polymer in the composite polymer is (14-20):(1-6), in one embodiment, the mass ratio is (15-20):(1-4), in one embodiment, the mass ratio is (16-18):(1-4). The mass ratio of the particles of the first polymer to the second polymer emulsion in the composite polymer being within the scope of the present application is conducive to coordinating the heat resistance and adhesion of the separator, thereby promoting the separator to achieve optimal performance.

In some embodiments of the present application, the mass ratio of the composite polymer to the binder is (90-99.5):(0.5-10), in one embodiment, the mass ratio is (93-99):(1-7), in one embodiment, the mass ratio is (95-99):(1-5).

In some embodiments of the present application, the base membrane is a porous base membrane, and has a porosity of 30%-80%.

In some embodiments of the present application, the base membrane includes any one of polyolefin porous base membrane, non-woven porous base membrane, or polyvinylidene fluoride porous base membrane.

In some embodiments of the present application, by testing and comparing the thermal stability, liquid retention rate, ionic conductivity, and peel strength of the composite separator of the present application and other separators of comparative example, the results show that the composite separator of the present application can simultaneously maintain optimal levels in all aspects, especially in thermal stability, liquid retention rate, and ionic conductivity, which are significantly better than those of the separators of comparative example.

In the third aspect of the present application, an electric device is provided, including the above secondary battery.

In some embodiments of the present application, the coating sides of the composite separator are thermally compressed and compounded with the positive and negative electrode sheets respectively for battery assembly.

In other embodiments of the present application, the positive electrode sheet includes a positive electrode active material, and the positive electrode active material may include at least one of ternary lithium positive electrode material and lithium iron phosphate positive electrode material; the negative electrode sheet includes a negative electrode active material, and the negative electrode active material may include at least one of graphite and silicon-oxygen composite material; the conductive agent may include carbon black, conductive graphite, VGCF (vapor grown carbon fiber), carbon nanotubes, and graphene, etc.; the binder may include at least one of polyvinylidene fluoride (PVDF), carboxymethyl cellulose (CMC), styrene-butadiene rubber (SBR), polyacrylic acid (PAA) and its salts, polytetrafluoroethylene (PTFE), and polyvinyl alcohol (PVA); the current collector may select at least one of metal foils with good conductivity, such as aluminum foil and copper foil; the lithium-ion battery of the present application can be a full cell, half cell, or symmetric cell, and can also be a button cell or a pouch cell.

In some embodiments of the present application, the electrolyte may utilize 1-1.5M lithium hexafluorophosphate electrolyte. In some embodiments, 1M lithium hexafluorophosphate is used as the lithium salt; and ethylene carbonate EC, dimethyl carbonate DMC, and ethyl methyl carbonate EMC are mixed in a volume ratio of 1:1:1 to form a solvent, serving as the battery electrolyte.

In the comparative tests provided in this application, unless otherwise specified, all experimental conditions and materials remain consistent across groups except for the differences indicated, ensuring comparability. Furthermore, all materials used in this application are commercially available.

The following further illustrates the secondary battery and its preparation method provided by the present application.

### Example 1

### (1) Preparation of Separator

Polybenzimidazoleimide (melting point: 270° C.) particles with a particle size of 1 μm were provided; and polyacrylic acid-polymethyl methacrylate copolymer (softening temperature: 50° C.) emulsion with a particle size of 0.2 μm was provided;
the polyacrylic acid-polymethyl methacrylate copolymer was loaded on the polybenzimidazoleimide particles, and the polybenzimidazoleimide particles and polyacrylic acid-polymethyl methacrylate copolymer were mixed at a mass ratio of 17:3, heated to 50° C. and stirred for 1 h, and dried at 60° C. to prepare a composite polymer, where the SEM image of the composite polymer morphology was shown in FIG. 2;
a water-based binder PVDF was added to the composite polymer, and deionized water was further added to prepare a slurry, where the amount of composite polymer added is 98% of the slurry mass, the amount of water-based binder added is 2% of the slurry mass, and the amount of deionized water added is 50 wt % of the powder mass;
a porous base membrane, specifically a polyethylene base membrane was provided, with a porosity of 40%;
the slurry was applied to one side of the porous base membrane, and dried at 60° C. to obtain a composite separator with a coating thickness of 3 μm.

### (2) Preparation of Positive Electrode Sheet

Ternary positive electrode active material NCM622, polyvinylidene fluoride, and conductive carbon black were added in a mass ratio of 96:2:2 to N-methylpyrrolidone solvent and stirred evenly; and the mixture obtained was coated on an aluminum foil, and then dried, rolled, and slit to obtain the positive electrode sheet.

### (3) Preparation of Negative Electrode Sheet

Anode active material graphite, conductive carbon black, and carboxymethyl cellulose (CMC) were added in a mass ratio of 96:2:2 to deionized water, and stirred evenly; and the mixture obtained was coated on a copper foil, and then dried, rolled, and slit to prepare the negative electrode sheet.

### (4) Preparation of Electrolyte

Lithium hexafluorophosphate was dissolved in a mixed solution of ethylene carbonate, dimethyl carbonate, and ethyl methyl carbonate to obtain the electrolyte, where the mass ratio of ethylene carbonate, dimethyl carbonate, and ethyl methyl carbonate was 1:1:1; and the concentration of lithium hexafluorophosphate is 1M in the electrolyte.

### (5) Preparation of Battery

The prepared positive electrode sheet, separator, and negative electrode sheet were stacked in sequence, with the separator being disposed between the positive and negative electrode sheets, and subjected to winding, hot-pressing and shaping, and tab-welding to form a bare core; the bare core was placed in an outer aluminum-plastic film package and baked in an oven at 85±10° C. for 24 hours; the prepared electrolyte was then injected into the dried battery, followed by standing, formation, and capacity grading, thereby completing the preparation of the lithium-ion pouch battery.

### Other Examples and Comparative Examples

The composite separator is prepared referring to the preparation method described in Example 1, and the differences are shown in Table 1 below.

TABLE 1

| | | | Mass ratio | Mass | | | | |
|---|---|---|---|---|---|---|---|---|
| | | | of the | percentage | | | | |
| | | | particles | of the | Type and | Type and | Particle | |
| | | Type and | of first | composite | mass | porosity | size | |
| | Type and | softening | polymer to | polymer | percentage | of the | of the | Thickness |
| | melting point | temperature of | the emulsion | in the | of the | base | composite | of the |
| | of the first | the second | of second | slurry | binder | membrane | polymer | coating |
| | polymer | polymer | polymer | (%) | (%) | (%) | (μm) | (μm) |
| Example 1 | Polybenzimidazoleimide: | Polyacrylic | 17:3 | 98 | PVDF: | Polyethylene | 1.5 | 3 |
| | 270° C. | acid- | | | 2 | base | | |
| | | polymethyl | | | | membrane: | | |
| | | methacrylate | | | | 40 | | |
| | | copolymer: | | | | | | |
| | | 50° C. | | | | | | |
| Example 2 | Polybenzazole: | Polyacrylic | 17:3 | 98 | PVDF: | Polyethylene | 1.3 | 3 |
| | 320° C. | acid- | | | 2 | base | | |
| | | polymethyl | | | | membrane: | | |
| | | methacrylate | | | | 40 | | |
| | | copolymer: | | | | | | |
| | | 50° C. | | | | | | |
| Example 3 | Polyether | Polyacrylic | 17:3 | 98 | PVDF: | Polyethylene | 1 | 3 |
| | sulfone: | acid- | | | 2 | base | | |
| | 230° C. | polymethyl | | | | membrane: | | |
| | | methacrylate | | | | 40 | | |
| | | copolymer: | | | | | | |
| | | 50° C. | | | | | | |
| Example 4 | Polybenzimidazoleimide: | Nitrile rubber: | 17:3 | 98 | PVDF: | Polyethylene | 1.5 | 3 |
| | 270° C. | 45° C. | | | 2 | base | | |
| | | | | | | membrane: | | |
| | | | | | | 40 | | |
| Example 5 | Polybenzimidazoleimide: | Polyvinyl | 17:3 | 98 | PVDF: | Polyethylene | 1.8 | 3 |
| | 270° C. | alcohols: 55° C. | | | 2 | base | | |
| | | | | | | membrane: | | |
| | | | | | | 40 | | |
| Example 6 | Polybenzimidazoleimide: | Polyacrylic | 14:3 | 98 | PVDF: | Polyethylene | 2.1 | 3 |
| | 270° C. | acid- | | | 2 | base | | |
| | | polymethyl | | | | membrane: | | |
| | | methacrylate | | | | 40 | | |
| | | copolymer: | | | | | | |
| | | 50° C. | | | | | | |
| Example 7 | Polybenzimidazoleimide: | Polyacrylic | 19:3 | 98 | PVDF: | Polyethylene | 1.7 | 3 |
| | 270° C. | acid- | | | 2 | base | | |
| | | polymethyl | | | | membrane: | | |
| | | methacrylate | | | | 40 | | |
| | | copolymer: | | | | | | |
| | | 50° C. | | | | | | |
| Example 8 | Polybenzimidazoleimide: | Polyacrylic | 17:1 | 98 | PVDF: | Polyethylene | 1.6 | 3 |
| | 270° C. | acid- | | | 2 | base | | |
| | | polymethyl | | | | membrane: | | |
| | | methacrylate | | | | 40 | | |
| | | copolymer: | | | | | | |
| | | 50° C. | | | | | | |
| Example 9 | Polybenzimidazoleimide: | Polyacrylic | 17:5 | 98 | PVDF: | Polyethylene | 1.7 | 3 |
| | 270° C. | acid- | | | 2 | base | | |
| | | polymethyl | | | | membrane: | | |
| | | methacrylate | | | | 40 | | |
| | | copolymer: | | | | | | |
| | | 50° C. | | | | | | |
| Example 10 | Polybenzimidazoleimide: | Polyacrylic | 17:3 | 98 | PVDF: | Polyethylene | 1.5 | 1 |
| | 270° C. | acid- | | | 2 | base | | |
| | | polymethyl | | | | membrane: | | |
| | | methacrylate | | | | 40 | | |
| | | copolymer: | | | | | | |
| | | 50° C. | | | | | | |
| Example 11 | Polybenzimidazoleimide: | Polyacrylic | 17:3 | 98 | PVDF: | Polyethylene | 1.5 | 5 |
| | 270° C. | acid- | | | 2 | base | | |
| | | polymethyl | | | | membrane: | | |
| | | methacrylate | | | | 40 | | |
| | | copolymer: | | | | | | |
| | | 50° C. | | | | | | |
| Example 12 | Polybenzimidazoleimide: | Polyacrylic | 17:3 | 98 | PVDF: | Polyethylene | 1.5 | 7 |
| | 270° C. | acid- | | | 2 | base | | |
| | | polymethyl | | | | membrane: | | |
| | | methacrylate | | | | 40 | | |
| | | copolymer: | | | | | | |
| | | 50° C. | | | | | | |
| Example 13 | Polybenzimidazoleimide: | Polyacrylic | 17:3 | 98 | PVDF: | Polyethylene | 1.5 | 3 |
| | 270° C. | acid- | | | 2 | base | | |
| | | polymethyl | | | | membrane: | | |
| | | methacrylate | | | | 50 | | |
| | | copolymer: | | | | | | |
| | | 50° C. | | | | | | |
| Example 14 | Polybenzimidazoleimide: | Polyacrylic | 17:3 | 98 | PVDF: | Polypropylene | 1.5 | 3 |
| | 270° C. | acid- | | | 2 | base | | |
| | | polymethyl | | | | membrane: | | |
| | | methacrylate | | | | 45 | | |
| | | copolymer: | | | | | | |
| | | 50° C. | | | | | | |
| Example 15 | Polybenzimidazoleimide: | Polyacrylic | 17:3 | 99 | PVDF: | Polyethylene | 1.5 | 3 |
| | 270° C. | acid- | | | 1 | base | | |
| | | polymethyl | | | | membrane: | | |
| | | methacrylate | | | | 40 | | |
| | | copolymer: | | | | | | |
| | | 50° C. | | | | | | |
| Example 16 | Polybenzimidazoleimide: | Polyacrylic | 17:3 | 92 | PVDF: | Polyethylene | 1.5 | 3 |
| | 270° C. | acid- | | | 8 | base | | |
| | | polymethyl | | | | membrane: | | |
| | | methacrylate | | | | 40 | | |
| | | copolymer: | | | | | | |
| | | 50° C. | | | | | | |
| Example 17 | Polybenzimidazoleimide: | Polyacrylic | 17:3 | 98 | CMC: | Polyethylene | 1.5 | 3 |
| | 270° C. | acid- | | | 2 | base | | |
| | | polymethyl | | | | membrane: | | |
| | | methacrylate | | | | 40 | | |
| | | copolymer: | | | | | | |
| | | 50° C. | | | | | | |
| Example 18 | Polybenzimidazoleimide: | Polyacrylic | 17:3 | 98 | SBR: | Polyethylene | 1.5 | 3 |
| | 270° C. | acid- | | | 2 | base | | |
| | | polymethyl | | | | membrane: | | |
| | | methacrylate | | | | 40 | | |
| | | copolymer: | | | | | | |
| | | 50° C. | | | | | | |
| Comparative | Polybenzimidazoleimide: | — | — | The first | PVDF: | Polyethylene | The | 3 |
| Example 1 | 270° C. | | | polymer | 2 | base | particle | |
| | | | | accounts | | membrane: | size | |
| | | | | for 98% | | 40 | of the | |
| | | | | of the | | | first | |
| | | | | slurry | | | polymer: | |
| | | | | | | | 1 | |
| Comparative | — | Polyacrylic | — | The | PVDF: | Polyethylene | The | 3 |
| Example 2 | | acid- | | second | 2 | base | particle | |
| | | polymethyl | | polymer | | membrane: | size | |
| | | methacrylate | | accounts | | 40 | of the | |
| | | copolymer: | | for 98% | | | second | |
| | | 50° C. | | of the | | | polymer: | |
| | | | | slurry | | | 0.5 | |
| Comparative | — | — | — | — | — | Polyethylene | — | — |
| Example 3 | | | | | | base | | |
| | | | | | | membrane: | | |
| | | | | | | 40 | | |
| Comparative | — | — | — | — | PVDF: | Polyethylene | — | Alumina |
| Example 4 | | | | | 2 | base | | coating: |
| | | | | | | membrane: | | 3 |
| | | | | | | 40 | | |
| Comparative | Polyethylene: | Polyvinylidene | 17:3 | 98 | PVDF: | Polyethylene | 1.5 | 3 |
| Example 5 | 130° C. | fluoride- | | | 2 | base | | |
| | | hexafluoropropylene | | | | membrane: | | |
| | | copolymer: | | | | 40 | | |
| | | 85° C. | | | | | | |

Adhesion performance between separator and electrode sheet: the coating sides of the separator were thermally compressed and compounded with the positive and negative electrode sheets respectively under conditions of 60° C. and 2 MPa; and the peel strength between the separator and the electrode sheet was tested using a universal tensile testing machine and recorded. The peel strength is shown in Table 2.

Thermal shrinkage performance of separator: the prepared separator was stamped into a fixed specification (100 mm×50 mm) for thermal shrinkage testing, the test conditions including 100° C./1 h and 130° C./0.5 h. The test results are shown in Table 2.

Ionic conductivity of separator: the prepared separator was used to prepare a symmetric cell to characterize the ionic conductivity of the separator itself. The test results are shown in Table 2. The specific method for preparing the symmetric battery was as follows: using a copper foil as an electrode, and using a conventional lithium-ion battery electrolyte (1M lithium hexafluorophosphate as the lithium salt, and ethylene carbonate (EC), dimethyl carbonate (DMC), and ethyl methyl carbonate (EMC) mixed in a 1:1:1 volume ratio as the solvent) as the electrolyte for symmetric cell. The cells were then assembled with a separator for testing.

Liquid retention volume of separator: the separator was stamped into a certain size and weighed; after fully immersed in the above electrolyte, it was taken out, and weighed again after the surface electrolyte was wiped off. The liquid retention volume and liquid retention rate were calculated. The liquid retention rate is recorded in Table 2.

TABLE 2

| | Peel strength N/m | | Thermal | | Thermal | | Separator | Liquid |
|---|---|---|---|---|---|---|---|---|
| | Separator/ | Separator/ | shrinkage % | | shrinkage % | | ionic | retention |
| | Positive | Negative | 100° C./1 h | | 130° C./0.5 h | | conductivity | rate |
| Scheme | electrode | electrode | MD | TD | MD | TD | (mS/cm) | (%) |
| Example 1 | 2.8 | 3.5 | 0.2 | 0 | 2 | 1.2 | 2.26 | 140 |
| Example 2 | 3 | 3.2 | 0.2 | 0 | 2 | 1 | 2.3 | 144.2 |
| Example 3 | 3 | 3.3 | 0.3 | 0 | 2.2 | 1.5 | 2.23 | 138.6 |
| Example 4 | 3.2 | 2.9 | 0.3 | 0 | 2.3 | 1.3 | 2.25 | 139 |
| Example 5 | 3.2 | 3.3 | 0.2 | 0 | 2.3 | 1 | 2.28 | 141 |
| Example 6 | 2.6 | 3.2 | 0.3 | 0 | 2.5 | 1.6 | 2.02 | 136.2 |
| Example 7 | 3 | 3.8 | 0.2 | 0 | 1.8 | 1.2 | 2.31 | 145.6 |
| Example 8 | 2 | 2.6 | 0.3 | 0 | 2.6 | 1.6 | 2.1 | 137.8 |
| Example 9 | 2.5 | 3.2 | 0.2 | 0 | 2.2 | 1.4 | 2 | 138.2 |
| Example 10 | 2.4 | 3 | 0.6 | 0.1 | 3.8 | 3 | 1.8 | 100.6 |
| Example 11 | 2.8 | 3.4 | 0 | 0 | 1 | 1 | 2.5 | 204.2 |
| Example 12 | 2.3 | 3.1 | 0 | 0 | 1.5 | 1.8 | 2.1 | 180.6 |
| Example 13 | 2.8 | 3.4 | 0.3 | 0 | 2.4 | 1.3 | 2.3 | 141 |
| Example 14 | 2.8 | 3.5 | 0.2 | 0 | 2.3 | 1.3 | 2.38 | 142.6 |
| Example 15 | 2.7 | 3.3 | 0.3 | 0 | 2.3 | 1.5 | 2.36 | 143.3 |
| Example 16 | 2.5 | 3.1 | 0.3 | 0 | 2.2 | 1.4 | 2.19 | 141.6 |
| Example 17 | 2.8 | 3.4 | 0.2 | 0 | 2.1 | 1.1 | 2.23 | 140.8 |
| Example 18 | 2.7 | 3.4 | 0.3 | 0 | 2 | 1.2 | 2.25 | 140.2 |
| Comparative | 0 | 0 | 0.2 | 0.2 | 1.8 | 1.2 | 1.86 | 119 |
| Example 1 | | | | | | | | |
| Comparative | 3.7 | 3.9 | 1.6 | 0.2 | 7.6 | 7.2 | 1.8 | 103.2 |
| Example 2 | | | | | | | | |
| Comparative | 0 | 0 | 2 | 0.4 | 8.5 | 8 | 1.65 | 80.3 |
| Example 3 | | | | | | | | |
| Comparative | 0 | 0 | 0.2 | 0.2 | 2.5 | 1.6 | 1.84 | 130.8 |
| Example 4 | | | | | | | | |
| Comparative | 0.6 | 0 | 1 | 0.1 | 5.6 | 5 | 2.03 | 123.4 |
| Example 5 | | | | | | | | |

It can be seen from the comparison between Examples 1 to 5 and Comparative Example 3 that, when the separator coating has a core including a polymer with a melting point of 180° C.-400° C. and a cladding layer including a polymer with a softening temperature of 40° C.-70° C., it significantly affects the separator's peel strength, thermal shrinkage rate, ionic conductivity, liquid retention rate, etc. Polymers with high heat resistance and polymers with suitable softening temperatures exert a synergistic effect in the separator coating, promoting a certain degree of improvement in both the adhesion strength and heat resistance of the separator.

It can be seen from the comparison between Example 1 and Comparative Examples 1 and 2 that, when the separator coating lacks the polymer with high heat resistance, its heat resistance is poor, and when the separator coating lacks the polymer with high adhesion, its adhesion strength is poor. And from Examples 1, 7-9, it can be seen that the mass ratio of the polymer with high heat resistance to the polymer with high adhesion has a certain influence on the performance of the separator. When the mass ratio of the two is controlled within the scope of the present application, it is beneficial to balance the heat resistance and adhesion strength of the separator.

In summary, the separator coating used in the present application has a good improvement effect on the performance of the separator.

The above descriptions are merely specific embodiments of the present application, enabling those skilled in the art to understand or implement the present application. A variety of modifications to these embodiments will be apparent to those skilled in the art, and the general principles defined herein may be implemented in other embodiments without departing from the spirit or scope of the present application. Therefore, the present application shall not be intended to be limited to the embodiments described herein, but shall conform to the broadest scope consistent with the principles and novel features claimed herein.

What is claimed is:

1. A secondary battery, comprising a positive electrode sheet, a negative electrode sheet, and a separator, wherein
the separator comprises a base membrane and a coating disposed on at least one surface of the base membrane;
the coating comprises a composite polymer and a binder, the composite polymer comprising a first polymer for a core layer and a second polymer for a cladding layer disposed on a surface of the core layer;
a peel strength between the separator and the positive electrode sheet is 1-5 N/m; and
a thermal shrinkage rate of the separator in MD and TD directions is less than 5% at 130° C. for 0.5 h.

2. The secondary battery according to claim 1, wherein a peel strength between the separator and the negative electrode sheet is 1-5 N/m.

3. The secondary battery according to claim 1, wherein the first polymer comprises at least one of polybenzimidazoleimide, polybenzothiazole, polybenzazole, polybenzoxazinone, polyimidazopyrrolone, polyether sulfone, polyphenylene sulfide, polyether ketone, polydiphenyl ether, phenyl polyphenylene, polyparaxylene, bisphenol A-type polyarylate, poly(p-hydroxybenzoate), and polyparabanic acid.

4. The secondary battery according to claim 3, wherein a peel strength between the separator and the negative electrode sheet is 1-5 N/m.

5. The secondary battery according to claim 1, wherein a melting point of the first polymer is 180-400° C.

6. The secondary battery according to claim 5, wherein a peel strength between the separator and the negative electrode sheet is 1-5 N/m.

7. The secondary battery according to claim 1, wherein the second polymer comprises at least one of polyacrylics, polyacrylates, nitrile rubber, chloroprene rubber, polyvinyl alcohols, and copolymers formed from any two thereof.

8. The secondary battery according to claim 1, wherein a softening temperature of the second polymer is 40-70° C.

9. The secondary battery according to claim 1, wherein a particle size of the composite polymer is 0.1-10 μm.

10. The secondary battery according to claim 1, wherein the binder comprises at least one of vinylidene fluoride, carboxymethyl cellulose, and styrene-butadiene rubber.

11. The secondary battery according to claim 1, wherein a thickness of the coating is 0.2-10 μm.

12. A preparation method for the separator of the secondary battery according to claim 1, comprising:
adding particles of the first polymer into an emulsion of the second polymer, then mixing, stirring, heating, and drying to obtain the composite polymer;
mixing the composite polymer, the binder, and water to form a slurry, applying the slurry on the at least one surface of the base membrane, curing to form the coating, and obtaining the separator.

13. The preparation method for the separator of the secondary battery according to claim 12, wherein a peel strength between the separator and the negative electrode sheet is 1-5 N/m.

14. The preparation method for the separator of the secondary battery according to claim 12, wherein the stirring and heating comprise heating to 40-100° C. and stirring for 0.5-10 h.

15. The preparation method for the separator of the secondary battery according to claim 12, wherein the drying is performed at 50-85° C.

16. The preparation method for the separator of the secondary battery according to claim 12, wherein a mass ratio of the particles of the first polymer to the emulsion of the second polymer is (14-20):(1-6).

17. The preparation method for the separator of the secondary battery according to claim 10, wherein a mass ratio of the composite polymer to the binder is (90-99.5):(0.5-10).

18. An electric device, comprising the secondary battery according to claim 1.
